(19) United States
(12) Patent Application Publication
(10) Pub. No.: US 2006/0038315 A1
(43) Pub. Date: Feb. 23, 2006

(54) Oxygen tailoring of polyethylene resins

(76) Inventors: Herbert Rodney Tunnell III, Charleston, WV (US); Porter Clarke Shannon, Seabrook, TX (US); Pradeep Pandurang Shirodkar, Stow, OH (US); Dongming Li, Houston, TX (US); Thomas Redden Veariel, Houston, TX (US)

Correspondence Address: Univation Technologies, LLC, Suite 1950, 5555 San Felipe, Houston, TX, 77056, US

(21) Appl. No.: 11/185,068

(22) Filed: Jul. 19, 2005

Related U.S. Application Data
(60) Provisional application No. 60/602,936, filed on Aug. 19, 2004.

(51) Int. Cl. B29C 47/00

(52) U.S. Cl. 264/210.3

(57) ABSTRACT

Methods of tailoring polyethylenes are contemplated utilizing 0.5 to 7.95 volume percent oxygen containing gases. The tailoring occurs in a melt-conveying zone of a mixer/extruder, and not in the feed or melting zones of a mixer/extruder. The effect of tailoring is to increase elasticity (G′/G″) of the polyethylenes more than 10 percent over similar polyethylenes that are extruded/mixed in the substantial absence of oxygen of oxygen containing gases.

### CROSS-REFERENCE TO RELATED APPLICATION

The present application claims priority to Provisional U.S. Patent Application Ser. No. 60/602,936 filed Aug. 19, 2004 and is herein incorporated by reference.

### TECHNICAL FIELD

Embodiments of our invention provide methods of intentionally modifying the rheology of polyethylenes during pelletization in order to improve final product properties such as bubble stability and gauge uniformity for polyethylene film applications or swell and sag for blow molding and pipe applications.

### BACKGROUND

Tailoring of resins, such as polyethylene homopolymer or copolymer resins, is a well-known method of altering the molecular architecture and thus the bulk properties of the resin and articles made therefrom. Tailoring involves treating the polyethylene resin with an agent, such as a peroxide or oxygen, capable of controlled modification of the resin. The effect of tailoring on the polyethylene resin rheological properties may generally be an increase in the zero shear viscosity, an increase in elasticity (G′/G″) and an increase in shear thinning behavior of the tailored pellets in comparison to the untailored granular product. These changes benefit the process of converting polyethylene pellets into final useful articles by reducing swell during the blow molding process, reducing sag during pipe extrusion, increasing the bubble stability and reducing gauge variation during film conversion.

Polyolefin resins having multimodal molecular weight distributions and/or multimodal composition distributions are desirable in a number of applications. Multimodal polyethylenes contain two or more molecular weight components or composition distributions. Sometimes multimodal resins containing two components are called bimodal. Such polyolefin resins generally include at least a mixture of a relatively higher molecular weight polyolefin and a relatively lower molecular weight polyolefin. Such polyolefin resins may be produced to take advantage of the increased strength properties of higher molecular weight resins and articles and films made therefrom, and the better processing characteristics of lower molecular weight resins.

Multimodal resins can be produced in tandem reactors, such as tandem gas phase reactors or tandem slurry reactors. Alternatively, bimetallic catalysts such as those disclosed in U.S. Pat. Nos. 5,032,562 and 5,525,678, and European Patent EP 0 729 387, can produce a multimodal polyolefin resins in a single reactor. These catalysts typically include a non-metallocene catalyst component and a metallocene catalyst component which produce polyolefins having different average molecular weights. U.S. Pat. No. 5,525,678, for example, discloses a bimetallic catalyst in one embodiment including a titanium non-metallocene component which produces a higher molecular weight resin, and a zirconium metallocene component which produces a lower molecular weight resin. Controlling the relative amounts of each catalyst in a reactor, or the relative reactivities of the different catalysts, allows control of the multimodal product resin.

A particularly useful application for multimodal polyethylene resins is in films. Frequently, however, the bubble stability and gauge uniformity of medium density polyethylene (MDPE) resins and high density polyethylene (HDPE) resins are not adequate for producing thin films. Attempts have been made to tailor polyethylene resins to improve bubble stability, gauge uniformity, and/or otherwise improve resin or film properties; see, e.g., European Patent Publication No. EP 0 457 441, and U.S. Pat. Nos. 5,728,335; 5,739,266; and 6,147,167. Other background references include FR 2,251,576; EP 0 180 444; U.S. Pat. No. 5,578,682; EP 0 728 796; and GB 1,201,060.

In WO 03/047839, oxygen tailoring is suggested to increase shear thinning behavior, increase elasticity, increase melt tension, reduce swelling during blow molding, and increase bubble stability during film blowing. This document suggests that this is accomplished using 8 to 40% by volume oxygen in the melt conveying section of the extruder. There is no suggestion to a lower amount of oxygen, to achieve such ends.

In U.S. Pat. No. 5,739,266, modifying a polyethylene in an extruder by bringing the polyethylene in contact oxygen or a gas mixture containing oxygen is suggested. This document suggests that the polymer is contacted with oxygen before it melts, and further suggests that the oxygen contact is performed before complete melting of the polymer. Additionally, this document suggests that the polymer-oxygen contact may occur in any part of the extruder, with the exception of the pumping or melt-conveying zone. The gas mixture suggested in this document contains from 1 to 50% by volume oxygen, when measured in the gas atmosphere of a feed hopper of the extruder.

It would be commercially advantageous to have improved methods of tailoring polyethylene, particularly polyethylene film resin, to provide polyethylene resins having improved bubble stability and gauge uniformity when such resins are processed into films.

### SUMMARY

In one embodiment a process for extruding/pelletizing a polyethylene is contemplated, comprising: a) providing a polyethylene to a mixer/extruder; b) conveying said polyethylene through a mixer/extruder, said mixer/extruder comprising a melt-conveying zone, wherein in the melt-conveying zone the polyethylene is substantially melted; c) contacting the substantially melted polyethylene with a gas mixture comprising 0.5 to 7.9 volume % oxygen, to produce an oxygen-treated polyethylene, wherein the contacting occurs in the melt-conveying zone.

In another embodiment, a process for producing a polyethylene resin useful in blown film is contemplated, the resin having improved bubble stability during blown film extrusion, comprising: a) introducing a granular polyethylene homopolymer or copolymer into a mixer/extruder; b) conveying the granular polyethylene through a feed zone, and/or a melting zone and a melt-conveying zone of the mixer/extruder; c) introducing a gas mixture to the melt-conveying zone, the melt-conveying zone comprising the gas mixture the polyethylene homopolymer or copolymer substantially melted, the gas mixture comprising in the range of 2.5% to 4.5% by volume oxygen, the remainder of the gas mixture comprising a non-reactive gas or a mixture of non-reactive gases, the gas mixture flowing in one of, the same direction or opposite direction of the substantially melted polyethylene homopolymer or copolymer in the melt-conveying zone, to form an oxygen treated polyethylene homopolymer or copolymer; and d) processing the oxygen-treated polyethylene homopolymer or copolymer further by: i) pelletizing; or ii) forming into a film; or iii) pelletizing and forming into a film; wherein the polyethylene homopolymer or copolymer comprises a density of 0.930 g/cm³-0.970 g/cm³, and an elasticity (G′/G″) at least 30% higher than a comparable polyethylene homopolymer or copolymer mixed/extruded in the substantial absence of oxygen.

Also contemplated is a process for producing a polyethylene having improved bubble stability and improved gauge uniformity during blown film production, comprising: a) introducing a granular polyethylene homopolymer or copolymer into a mixer/extruder; b) conveying the granular polyethylene through a feed zone, and/or a melting zone and a melt-conveying zone of the mixer/extruder; c) introducing a gas mixture to said melt-conveying zone, the melt-conveying zone consisting essentially of an extruder screw element and barrel, the gas mixture and said polyethylene homopolymer or copolymer, substantially melted; the gas mixture comprising in the range of 3% to 4% by volume oxygen, the remainder of the gas mixture comprising a non-reactive gas or a mixture of non-reactive gases, the gas mixture flowing in one of, the same direction or opposite direction of the substantially melted polyethylene homopolymer or copolymer in the melt-conveying zone, to form an oxygen treated polyethylene homopolymer or copolymer; and d) processing said oxygen-treated polyethylene homopolymer or copolymer further by: i) pelletizing; or ii) forming into a film; or iii) pelletizing and forming into a film; wherein the polyethylene homopolymer or copolymer comprises a density of 0.930 g/cm³-0.970 g/cm³, and an elasticity (G′/G″) at least 40% higher than a comparable polyethylene homopolymer or copolymer mixed/extruded in the substantial absence of oxygen.

Also contemplated is a process of tailoring a polyethylene, comprising: a) introducing a granular polyethylene into a mixer/extruder; b) conveying the granular polyethylene through a feed zone, and/or a melting zone and a melt-conveying zone of the mixer/extruder, wherein the feed zone and said melting zone are substantially free of oxygen; c) introducing a gas mixture to the melt-conveying zone, the melt-conveying zone comprising the gas mixture and the polyethylene, substantially melted; the gas mixture comprising in the range of 3% to 4% by volume oxygen, the remainder of the gas mixture comprising a non-reactive gas or a mixture of non-reactive gases, the gas mixture flowing in one of, the same direction or opposite direction of the substantially melted polyethylene homopolymer or copolymer in the melt-conveying zone, to form an oxygen treated polyethylene homopolymer or copolymer; and d) processing the oxygen-treated polyethylene further by: i) pelletizing; or ii) forming into a film; or iii) pelletizing and forming into a film; wherein the polyethylene homopolymer or copolymer comprises a density of 0.930 g/cm³-0.970 g/cm³, and an elasticity (G′/G″) at least 40% higher than a comparable polyethylene mixed/extruded in the substantial absence of oxygen.

### BRIEF DESCRIPTION OF THE DRAWINGS

FIG. 1 is a schematic diagram of a Kobe mixer.

FIG. 2 is a schematic diagram of a Farrel mixer.

FIG. 3 is a schematic diagram of a Werner-Pfleiderer mixer-extruder.

### DESCRIPTION

Polyethylene Resin

The polyethylene resins to be tailored in embodiments of our invention, may comprise a polyethylenes having a density from 0.900 g/cm³ to 0.970 g/cm³, including very low density polyethylene having a density from 0.900 g/cm³ to 0.912 g/cm³, linear low density polyethylene having a density from 0.912 g/cm³ to 0.930 g/cm³, medium density polyethylene (MDPE) having a density typically in the range of 0.930 g/cm³ to 0.945 g/cm³; or a high density polyethylene (HDPEs) polyethylene having a density greater than 0.945 g/cm³ and up to 0.970 g/cm³. The polyethylene can be a homopolymer or a copolymer, with polymers having more than two types of comonomers, such as terpolymers, also included within the term “copolymer” as used herein. Suitable comonomers include α-olefins, such as C₃-C₂₀ α-olefins or C₃-C₁₂ α-olefins. The α-olefin comonomer can be linear or branched, and two or more comonomers can be used, if desired. Examples of suitable comonomers include linear C₃-C₁₂ α-olefins, and α-olefins having one or more C₁-C₃ alkyl branches, or an aryl group. Specific examples include propylene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. It should be appreciated that the list of comonomers above is merely exemplary, and is not intended to be limiting.

In another embodiment, the polyethylene resin has a multimodal or unimodal molecular weight distribution and/or a multimodal or unimodal composition distribution. The resin can be produced in conventional processes, such as single or tandem gas phase fluidized bed reactors, or single or tandem slurry loop or supercritical loop reactors, using any catalyst capable of producing multimodal resins. The catalyst used is not particularly limited, and can include, for example, one or more Ziegler-Natta catalysts and/or one or more metallocene catalysts. Mixtures of catalysts can also be used. In particular, polymerization can be carried out with two or more different catalysts present and actively polymerizing at the same time, in a single reactor. The two or more catalysts can be of different catalyst types, such as a non-metallocene catalyst and a metallocene catalyst, to produce a polyethylene resin having desirable properties. The catalysts can be fed to the reactor separately or as a physical mixture, or each catalyst particle can contain more than one catalyst compound. When the catalysts include two catalysts producing polymers of different molecular weight and/or different comonomer content, the polymer product can have a multimodal distribution of molecular weight, comonomer, or both. Such multimodal products can have physical properties that are different from those that can be obtained from either catalyst alone, or from post-reactor mixing of the individual unimodal resins obtained from each catalyst alone.

For example, U.S. Pat. No. 5,525,678 discloses a catalyst including a zirconium metallocene that produces a relatively low molecular weight, high comonomer-content polymer, and a titanium non-metallocene that produces a relatively high molecular weight, low comonomer-content polymer. Typically, ethylene is the primary monomer, and small amounts of hexene or other alpha-olefins are added to lower the density of the polyethylene. The zirconium catalyst incorporates most of the comonomer and hydrogen, so that, in a typical example, about 85% of the hexene and 92% of the hydrogen are in the low molecular weight polymer. Water is added to control the overall molecular weight by controlling the activity of the zirconium catalyst.

Other examples of suitable catalysts include Zr/Ti catalysts disclosed in U.S. Pat. No. 4,554,265; mixed chromium catalysts disclosed in U.S. Pat. Nos. 5,155,079 and 5,198,399; Zr/V and Ti/V catalysts disclosed in U.S. Pat. Nos. 5,395,540 and 5,405,817; the hafnium/bulky ligand metallocene mixed catalysts disclosed in U.S. Pat. No. 6,271,323; and the mixed metallocene catalysts disclosed in U.S. Pat. No. 6,207,606.

Also contemplated are physical blends of at least two polyethylenes, each of which may be produced in one or more reactors, which when put together have a multimodal molecular weight distribution and/or a multimodal composition distribution.

Multimodal resins can contain any number of components. Typically, multimodal resins comprise at least component having a melt index I₂ of 100 to 9000 dg/min called the lower molecular weight (LMW) component, and at least one component having a flow index I_{21.6} of 0.1 to 1 dg/min called the higher molecular weight component (HMW). A multimodal resin contains at least two components where the relative weight fraction of the HMW and LMW components can be from 1:9 to 9:1. A typical bimodal resin has a HMW weight fraction of 45% to 70% (the balance comprising LMW weight fraction) and comprises a flow index (I_{21.6}) of 5 to 15 dg/min.

We also contemplate unimodal molecular weight distribution and/or unimodal composition distribution polyethylene resins, as well as multimodal (two or more) molecular weight distribution and/or multimodal (two or more) composition distributions.

Any of the polyethylene resins discussed herein can be the product of only one catalyst or any combination of polyolefin catalysts. The types of catalysts include, any one or more transition metal catalysts composed in part of elements from groups III, IV, V, VI, VII, VIII, IX, X, XI and XII on the periodic table. Examples of some of these catalysts include metallocene catalysts based on Zirconium and Hafnium as well as traditional catalysts based Magnesium. Chromium, Titanium and Vanadium.

Mixer-Extruder

The polyethylene resin may be processed in a mixer, such as a co- or counter-rotating, intermeshing or non-intermeshing twin screw mixer or an extruder. Such mixers are well-known in the art, and are commercially available from various sources, such as Coperion (Werner-Pfleiderer), Kobelco and Farrel. The resin is usually fed, by means of a hopper, to the feeding zone of the mixer, in this zone the temperature is generally below the melting temperature of the resin as the resin is compressed and conveyed toward the melting zone. Typically, the temperature in the feeding zone is 20 to 100° C., and may be maintained by cooling the extruder walls. In the melting zone, the temperature is increased to at least partially melt the resin, often in this zone, the resin is substantially all melted. In the melt conveying zone, the temperature is sufficient to maintain all of the melted resin in that state. By “substantially all”, we intend here that greater than 95 wt. % or greater than 97 wt. %, or greater than 99 wt. %, or 100% of the polyethylene is melted. Each zone may only be partially filled with the resin; by partially filled we intend 10-99% of the volume of any zone or zones are filled to such percentages by resin and any additives. Although the terms “mixer” and “extruder” are often used loosely and interchangeably, one skilled in the art will appreciate that mixers, such as the commercially available Kobe or Farrel mixers, operate at relatively low pressures, typically about 100 psi or less, and the zones within the mixer are generally not completely filled with resin. In extruders, such as are commercially available from, for example, Werner-Pfleiderer, operations may be at higher pressures in at least some zones, depending on modular screw/barrel design for that zone and the percentage of the zone that is filled with the resin and/or resin and additives, and the some of the various zones within the extruder may be generally completely filled with resin, and such zones will be generally at higher pressures.

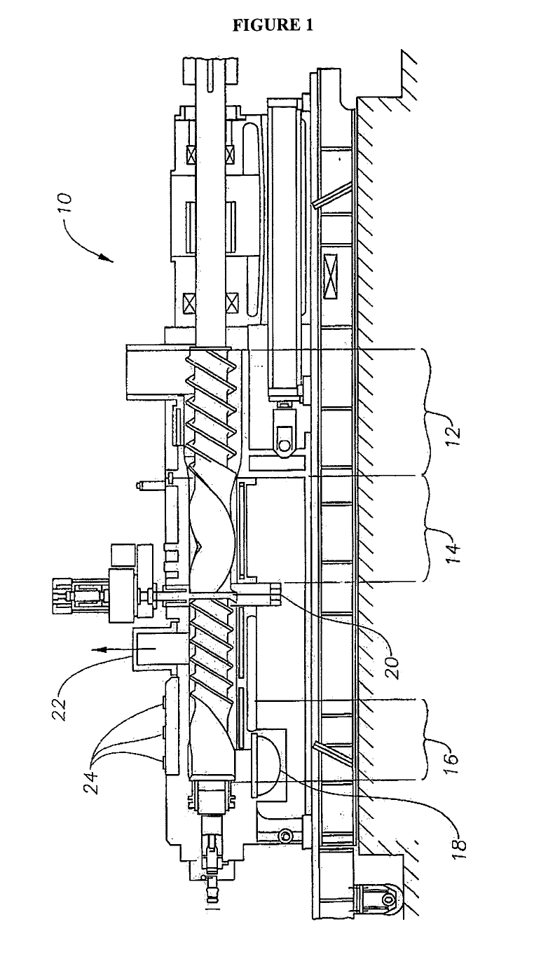

Although not limited to any particular mixer, an embodiment of the process of the invention is illustrated now by reference to FIG. 1, showing a schematic diagram of a Kobe mixer 10. Mixer 10 includes a feed zone 12, a melting zone 14, and a melt-conveying zone 16. Resin and optional additives are provided to mixer 10 in the feed zone 12, and the resin is conveyed in a downstream direction through the melting zone 14 and the melt-conveying zone 16. Gate 20 separates the melting zone 14 from the melt-conveying zone 16. An optional vent 22 is shown in FIG. 1 in the melt-conveying zone 16. As described above, the resin is generally at least partially melted in melting zone 14, and generally, substantially completely melted in melt-conveying zone 16. The resin is conveyed through the mixer discharge 18 and further processed, such as by pelletizing.

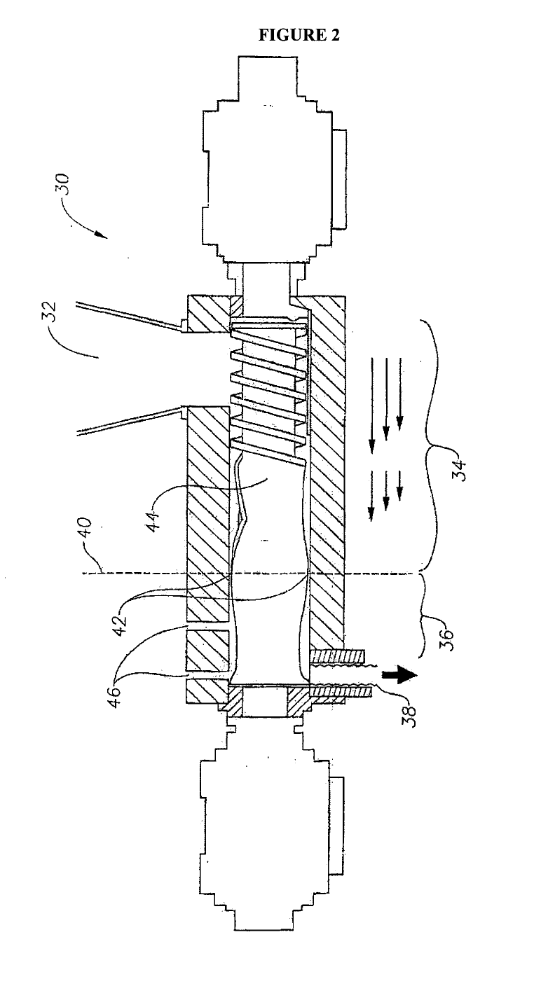

Turning now to FIG. 2, reference is made to a Farrel mixer 30. Mixer 30 includes a feed zone 32, a melting zone 34, and a melt-conveying zone 36. Resin and optional additives are provided to mixer 30 in the feed zone 32, and the resin is conveyed in a downstream direction through the melting zone 34 and the melt-conveying zone 36. As described above, the resin is generally at least partially melted in melting zone 34, and generally, substantially completely melted in melt-conveying zone 36. The resin is conveyed through the mixer discharge 38 and further processed, such as by pelletizing. The Farrel mixer does not have a gate such as gate 20 of the Kobe mixer separating the melting zone from the melt-conveying zone. However, melting zone 34 and melt-conveying zone 36 are effectively separated by a narrow clearance region shown by dashed line 40 corresponding to the apex 42 of mixing element 44. An optional dam (not shown) can be inserted between melting zone 34 and melt-conveying zone 36 at the position of line 40.

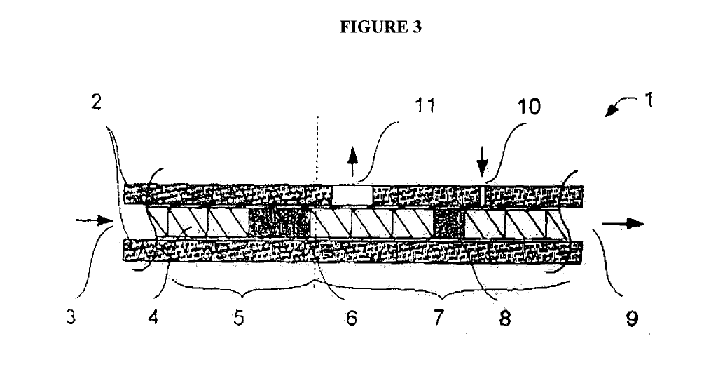

Turning now to FIG. 3, reference is made to a Werner-Pfleiderer extruder where the processing section (1) comprises a barrel or barrels (2), and screw or screws (4) made up of positive conveying elements, non-conveying elements and reverse-conveying elements. Resin (polyethylene) in either granule or pellet form, and optional additives are fed to the processing section (1) and conveyed from the feed end (3) to discharge end (9) with a melting zone created by kneading and reverse conveying elements of the screw (4), the processing section is divided into a melting zone (5) and a melt-conveying zone (7). The resin (polyethylene) is contacted with oxygen containing gas in the melt-conveying zone (only), by either the open vent port (11) or injecting oxygen containing gas stream from injecting port (10), in this latter case the gas stream (10a) will flow upstream against or counter to the melted polyethylene being conveyed from left to right, in which case the gas mixture exits at open vent port (11). Alternatively, the injecting port (10) can be placed upstream to the vent port (11), the gas mixture is injected in the injecting port (10), co-flows with molten resin, and exits from injecting port (11). The practical effect of either gas flow model is longer residence/contact time than simple contact at a vent port. Additionally, special elements (8) can be placed between (10) and (11) to increase interface generation for oxygen contact and increase local residence time of the melt. The gas can also contact the molten resin via a single port, where both entry and exit of the gas takes place from the same port. More than one “single port” may be used.

The resin can be processed at melt temperature of from a lower limit of 200° F. (104° C.), or 240° F. (116° C.), or 260° F. (127° C.), or 280° F. (138° C.,) or 300° F. (149° C.), or 350° F. (176° C.), or 400° F. (204° C.) to an upper limit of less than 536° F. (280° C.), or 518° F. (270° C.), or 500° F. (260° C.), or 430° F. (221° C.) or less than 420° F. (216° C.) or less than 410° F. (210° C.) or less than 400° F. (204° C.), where the melt temperature is the temperature at the downstream end of the melting zone. The melt temperature as used herein is the temperature of the melted polymer/polyethylene. Once such a polymer/polyethylene has transitioned from a solid, non-melted state, the temperature of the melted polymer/polyethylene can continue to rise. No matter the actual temperature, the melt temperature is understood to be the temperature of the polymer/polyethylene at least at its melting point, and above. For example, in FIG. 1, the melt temperature is the temperature at gate 20, in FIG. 2, the melt temperature is the temperature at the apex 42 and in FIG. 3 the melt temperature is the temperature at the discharge end (9) of the processing section after the last barrel.

It should be appreciated that mixers and/or extruders other than those named and illustrated herein can be used, as long as the mixer or extruder has a melt conveying zone that will allow the introduction of oxygen or an oxygen mix.

Oxidizing Agent

The resin is contacted with oxygen or an oxygen-gas mix in the melt-conveying zone. The oxygen or an oxygen-gas mix may be provided, for example, through one or more gas inlet ports. Referring to FIG. 1, for example, in some embodiments, oxygen or an oxygen-gas mix can be provided through one or more inlets 24. Referring to FIG. 2, for example, in some embodiments, oxygen or an oxygen-gas mix can be provided through one or more inlets 46. Referring to FIG. 3, for example, in some embodiments, oxygen or an oxygen mix can be provided through one or more inlets as noted above. It should be appreciated that these specific inlet positions are merely exemplary. In embodiments of our invention the feed hopper and/or the feed zone and/or the melting zone are substantially free of intentionally added oxygen or an oxygen-gas mix. By substantially free, we intend less than 2% by volume, or less than 1% by volume, or less than 0.5% by volume.

Oxygen or an oxygen-gas mix can be provided at a continuous flow of gas or, alternatively, oxygen can be provided intermittently. In an embodiment, the gas stream may be injected into the extruder/mixer barrel at a location upstream to a vent port. The gas may counter-flow with the molten polyethylene resin, or the gas may co-flow with the molten polyethylene. By oxygen, we intend oxygen, peroxides, or other reactive tailoring agents. While we discuss embodiments using oxygen or oxygen mixtures as the tailoring agent, other tailoring agents may also be used such as peroxides and/or other free radical initiators. Azo-compounds that can be used as free radical initiators are: 2,2′-Azo(2,4-dimethylpentanentrile) [Vazo® 52]; 2,2′-Azobisisobutyronitrile [Vazo64]; 2,2′-Azobis-(2-methylbutyronitrile) [Vazo 67] and 1,1′-Azocyclohexanecarbonitrile [Vazo 88], each available from E. I. Dupont. Additional free radical initiators include lauroyl peroxide; benzoyl peroxide; cyclohexanone peroxide; 1,1-Bis(tert-butylperoxy)-3,3,5-trimethylcyclohexane; tert-butylperoxy isopropyl carbonate; tert-butyl peracetate; 2,2-bis(tert-butylperoxy)butane; tert-butyl peroxybenzoate bis(1-(tert-butylperoxy)-1-methylethylcyclohexane; dicumyl peroxide 2,5-Bis(tert-butylperoxy)-2,5-dimethyl-3-hexyne; tert-butyl peroxide; 2,4-pentaneedione peroxide; and cumene hydroperoxide.

Oxygen gas can be provided as an essentially pure gas or as part of a gas mixture. The oxygen can be provided in a pre-mixed gas mixture, or co-fed to the extruder with a diluent gas, adjusting the amount of oxygen in the resulting mixture by adjusting relative oxygen/diluent gas flow rates. For example, oxygen and nitrogen can be fed to the extruder at separately metered flow rates to provide oxygen to the extruder at the desired concentration. Oxygen content of the gas stream may be varied to control the level of tailoring or effect upon the polyethylene resin. The oxygen level in the gas stream may be in the range of from 0.1 to 7.9 volume. %, or 0.25 to 7.5, or 0.5 to 7.0, or 0.75 to 6.5, or 1.0 to 6.0, or 1.5 to 5.5, or 2.0 to 5.0, or 2.5 to 4.75, or 2.75 to 4.5, or 3 to 4 volume percent.

The remainder of the gas mixture may be any non-flammable gas or gas mixture, such as nitrogen, argon, helium, neon, krypton, xenon, carbon dioxide, or mixtures thereof. After the oxygen treatment, or “tailoring”, the resin can be extruded through a die and pelletized and cooled, or can be directly extruded without pelletization to form a film, such as by a cast or blown film process.

Various additives can also be introduced into the extruder, as is conventional in the art.

Tailoring

Tailoring is the result of a chemical reaction between the tailoring agent, such as oxygen or oxygen containing agents such as peroxides, and the polymer. The tailoring, as measured by increases in elasticity, may be affected by one or more of temperature of the polymer, residence time of the contact of the tailoring agent (such as oxygen) with the polymer, the concentration of the tailoring agent and the concentration or residence time of anti-tailoring agents such as antioxidants and/or other stabilizing additives. In the case of tailoring agents like oxygen, where the relative solubility of oxygen in the polymer melt compared to the gas is low, most of the tailoring reaction occurs along the interface, so increasing the surface are of the interface can increase the extent of the tailoring. Any of these aforementioned variables may also be used to control the tailoring process.

After a polyethylene is tailored, the polyethylene will comprise an elasticity (G′/G″) at least 10, or 12, or 14, or 16, or 18, or 20, or 25, or 27, or 30, or, 35, or 40, or 45, or 50, or 55% greater than elasticity (G′/G″) of a non-tailored polyethylene extruded or mixed under similar conditions. By similar conditions we intend that the extrusion rates, extruder zone temperatures, screw design and other parameters are generally the same, save for normal process fluctuations. By non-tailored we mean a granular polyolefin mixed or extruded in such a way that the modification of its rheology is minimized. This minimization may be accomplished by excluding tailoring agents from the granular resin being extruded/mixed, and/or extruding/mixing the polyolefin with a non-reactive gas or gas mixture such as nitrogen and/or extruding/mixing the polyolefin with a high concentration of primary and/or secondary antioxidants and/or extruding/mixing the polyolefin at relatively low melt temperatures below, for instance, 200° C. Or non-tailored means extruded/mixed in the substantial absence of oxygen or an oxygen mixture, or in a nitrogen or non-reactive atmosphere. By the substantial absence of oxygen, we intend that less than 1, or less than 0.5, or less than 0.25, or less than 0.1, or less than 0.05, percent by volume oxygen, or oxygen containing gas such as air, are present in a given process or segment of a process.

Tailoring can be influenced by additives such as anti-oxidants and/or anti-ozonants such as phosphites and/or phosphonites. Generally, the more of such additives present in the polymer, the lower the amount and effect of tailoring for a given temperature, oxygen content and/or residence time. Such additives may be present in the polyethylene resin at a lower level from 0, or 2, or 5, or 10, or 20, or 30, or 40 parts per million (ppm) based on the polyethylene resin, other additives and any optional fillers, to an upper limit of 3000, or 2500, or 2000, or 1500, or 1000, or 750, or 500, or 400, or 300, or 200, or 100 ppm.

Another more particular embodiment is to a process for producing a polyethylene resin useful in blown film, said resin having improved bubble stability during blown film extrusion, comprising:

a) introducing a granular polyethylene homopolymer or copolymer into a mixer/extruder;

b) conveying said granular polyethylene through a feed zone, and/or a melting zone and a melt-conveying zone of said mixer/extruder;

c) introducing a gas mixture to said melt-conveying zone, said melt-conveying zone comprising said gas mixture said polyethylene homopolymer or copolymer substantially melted, said gas mixture comprising in the range of 2.5% to 4.5% by volume oxygen, the remainder of said gas mixture comprising a non-reactive gas or a mixture of non-reactive gases, said gas mixture flowing in one of, the same direction or opposite direction of said substantially melted polyethylene homopolymer or copolymer in said melt-conveying zone, to form an oxygen treated polyethylene homopolymer or copolymer;
d) processing said oxygen-treated polyethylene homopolymer or copolymer further by: i) pelletizing; or ii) forming into a film; or iii) pelletizing and forming into a film; wherein said polyethylene homopolymer or copolymer comprises a density of 0.930 g/cm³-0.970 g/cm³, and an elasticity (G′/G″) at least 30% higher than a comparable polyethylene homopolymer or copolymer mixed/extruded in the substantial absence of oxygen.

Yet another particular embodiment is to a process for producing a polyethylene having improved bubble stability and improved gauge uniformity during blown film production, comprising:

a) introducing a granular polyethylene homopolymer or copolymer into a mixer/extruder;

b) conveying said granular polyethylene through a feed zone, and/or a melting zone and a melt-conveying zone of said mixer/extruder;

c) introducing a gas mixture to said melt-conveying zone, said melt-conveying zone consisting essentially of an extruder screw element and barrel, said gas mixture and said polyethylene homopolymer or copolymer, substantially melted; said gas mixture comprising in the range of 3% to 4% by volume oxygen, the remainder of said gas mixture comprising a non-reactive gas or a mixture of non-reactive gases, said gas mixture flowing in one of, the same direction or opposite direction of said substantially melted polyethylene homopolymer or copolymer in said melt-conveying zone, to form an oxygen treated polyethylene homopolymer or copolymer;

d) processing said oxygen-treated polyethylene homopolymer or copolymer further by: i) pelletizing; or ii) forming into a film; or iii) pelletizing and forming into a film; wherein said polyethylene homopolymer or copolymer comprises a density of 0.930 g/cm³-0.970 g/cm³, and an elasticity (G′/G″) at least 40% higher than a comparable polyethylene homopolymer or copolymer mixed/extruded in the substantial absence of oxygen.

And yet another particular embodiment is to a process of tailoring a polyethylene, comprising:

a) introducing a granular polyethylene into a mixer/extruder;

b) conveying said granular polyethylene through a feed zone, and/or a melting zone and a melt-conveying zone of said mixer/extruder, wherein said feed zone and said melting zone are substantially free of oxygen;

c) introducing a gas mixture to said melt-conveying zone, said melt-conveying zone comprising said gas mixture and said polyethylene, substantially melted; said gas mixture comprising in the range of 3% to 4% by volume oxygen, the remainder of said gas mixture comprising a non-reactive gas or a mixture of non-reactive gases, said gas mixture flowing in one of, the same direction or opposite direction of said substantially melted polyethylene homopolymer or copolymer in said melt-conveying zone, to form an oxygen treated polyethylene homopolymer or copolymer;

d) processing said oxygen-treated polyethylene further by: i) pelletizing; or ii) forming into a film; or iii) pelletizing and forming into a film; wherein said polyethylene homopolymer or copolymer comprises a density of 0.930 g/cm³-0.970 g/cm³, and an elasticity (G′/G″) at least 40% higher than a comparable polyethylene mixed/extruded in the substantial absence of oxygen.

### EXAMPLES

The term “Melt Index” refers to the melt flow rate of the resin measured according to ASTM D-1238, condition E (190° C., 2.16 kg load), and is conventionally designated as 12.16. The term “Flow Index” (FI) refers to the melt flow rate of the resin measure according to ASTM D-1238, condition F (190° C., 21.6 kg load), and is conventionally designated as I_{21.6}. Melt index and flow index have units of g/10 min, or equivalently dg/min. The term “MFR” refers to the ratio I_{21.6}/I_{2.16}, and is dimensionless.

Specific Energy Input (SEI) refers to the energy input to the main drive of the extruder, per unit weight of melt processed resin, and is expressed in units of hp·hr/lb or kW·hr/kg.

“Elasticity” as used herein is the ratio of G′ to G″ at a frequency of 0.1 s⁻¹, where G′ and G″ are the storage (or elastic) and loss (or viscous) moduli, respectively. G′ and G″ were measured according to ASTM D-4440-84. Measurements were made at 200° C. using a Rheometrics DSR500 dynamic stress oscillatory rheometer equipped with 25 mm parallel plates and an approximate 1.5 mm gap.

Density (g/cm³) was determined using chips cut from plaques compression molded in accordance with ASTM D-1928-96 Procedure C, aged in accordance with ASTM D618 Procedure A, and measured according to ASTM D1505-96.

Oxygen was provided to an oxygen-nitrogen gas mixture. The oxygen level was controlled by varying the relative flows of oxygen and nitrogen. The oxygen level reported in the data tables was calculated from the volumetric flow rates of air and nitrogen.

### Example A

The base resin used was a bimodal HDPE resin produced in a commercial reactor using a bimetallic catalyst in a single gas phase fluidized-bed reactor. The bimetallic catalyst was a Ziegler-Natta/Metallocene catalyst as described in U.S. Pat. No. 6,403,181. The resin had a density of 0.953 g/cm³, a melt index I_{2.16} of 0.07 dg/min, a flow index I_{21.6} of 7.8 dg/min and an elasticity (G′/G″) of 0.53 in non-tailored state. The additives incorporated during compounding were 800 ppm of Irganox®-1010 and 200 ppm of Irgafos®-168 and 1500 ppm of Zinc Stearate.

The equipment used was a Coperion (Werner-Pfleiderer) ZSK-57 co-rotating twin screw extruder. The schematic diagram is FIG. 3, and the Figure shows the processing section of the machine (1). This processing section comprises barrels (2) and screws (4) made up of positive conveying elements, non-conveying elements and reverse-conveying elements. Resin, either in granule or pellet form, and optional additives were fed into the processing section (1) and conveyed from the feed end (3) to discharge end (9). The processing section is divided into a melting zone (5), created by kneading and reverse-conveying screw elements, and a melt-conveying zone (7). Examples of optional additives are antioxidant and polymer processing aid (PPA). In this example, a package of two antioxidants, Irganox®-1010 and Irgafos®-168, were used at a total concentration of 0.1% together with 0.15% of zinc stearate as PPA (polymer processing aid). The total amount of additives is 0.25%.

The resin was contacted with oxygen in the melt-conveying zone, by either injecting oxygen, an oxygen mixture or nitrogen (as shown in table 1) in the open vent port (11) or more effectively injecting oxygen or an oxygen mixture from injecting port (10). In the latter case, the gas stream flows upstream against the melt-conveying of the melted resin, then the gas stream escapes from the open port (11). The residence time was much longer than contact at a vent port. Further, neutral kneading elements were placed between (10) and (11) to increase interface generation for oxygen contact and increase the local residence time of the melted resin.

Oxygen content in the gas stream was varied to control the level of tailoring. The runs/experiments shown in Table 1 show that when the oxygen content was changed from 0% (using a nitrogen blanket) to 3%, and 6%, the elasticity changed from 0.54 to 0.64, and 0.69, respectively. These changes represent an increase of ranging from 21% to 30% over the non-tailored base resin.

TABLE I

| | Oxygen content in | | | | | % increase |
|---|---|---|---|---|---|---|
| Run # | injection gas stream | I2 | I21 | MFR | G′/G″ | in G′/G″ |
| 1 | 0% (Nitrogen) | 0.07 | 8.6 | 119.2 | 0.54 | 1 |
| 2 | 3% | 0.069 | 7.8 | 113.3 | 0.64 | 21 |
| 3 | 6% | 0.06 | 8.6 | 146.1 | 0.69 | 30 |

### Example B

The polymer used in this example is substantially the same polymer used in Example A. The compounding was conducted on a Kobe Steel LCM-320 equipped with an EL-2 rotor. 200 ppm Irganox-168, 800 ppm Irganox-1010, 500 ppm zinc stearate and 1000 ppm calcium stearate were added to the granular resin feed prior to introduction to the mixer. Oxygen was introduced to the melting zone, down stream of the gate as purified air and diluted with nitrogen to obtain 4% oxygen. Total gas flow was maintained at 3 Nm#/hr. The gate position, and thus the SEI, was adjusted to maintain the temperature in a constant range at the gate for each tailoring target.

Untailored data was determined by taking granular samples directly from the reactor. The samples were dry blended with 1500 ppm Irganox-1010, 1500 ppm Irganox-168 and 500 ppm zinc stearate. The blended sample was then introduced to a single screw extruder under a nitrogen blanket and melt homogenized. Pellets from the melt homogenized samples were evaluated, and the average of 2 samples, typically taken 1 hour apart, corresponding to a 20 tonne reactor production window were calculated.

When the same reactor resin from the 20 tonne production window was introduced to the Kobe LCM-320, samples were captured hourly, evaluated and averaged to determine the properties presented below (Table II). Again, the tailored averages typically involved 2 samples taken 1 hour apart. Compounder process data such as SEI and % Oxygen were averaged over the same 20 tonne window.

TABLE II

| | | | |
|---|---|---|---|
| Production tonnes | 200 | 300 | 400 |
| RXN Time Start | 5/2/2004 15:06 | 5/3/2004 05:00 | 5/3/2004 17:00 |
| RXN Time Stop | 5/2/2004 18:12 | 5/3/2004 07:18 | 5/3/2004 18:12 |

| | A | B | C |
|---|---|---|---|
| Untailored | | | |
| FI | 12.46 | 6.00 | 7.93 |
| MFR | 124 | 89 | 114 |
| Elasticity | 0.545 | 0.532 | 0.530 |
| Tailoring Conditions | | | |
| SEI | 193 | 197 | 206 |
| % Oxygen | 4% | 4% | 4% |
| Tailored Properties | | | |
| FI | 15.27 | 6.58 | 8.88 |
| MFR | 151 | 112 | 139 |
| Elasticity | 0.610 | 0.651 | 0.673 |
| % Change in Elasticity | 11.9% | 22.4% | 26.9% |
| % Change in MFR | 21.7% | 25.2% | 22.6% |
| Lot | 4EA14 | 4EA16 | 4EA18 |

We claim:

1. A process for extruding/pelletizing a polyethylene, comprising:
a) providing a polyethylene to a mixer/extruder;
b) conveying said polyethylene through a mixer/extruder, said mixer/extruder comprising a melt-conveying zone, wherein in said melt-conveying zone said polyethylene is substantially melted; and
c) contacting said substantially melted polyethylene with a gas mixture comprising 0.5 to 7.9 volume % oxygen, to produce an oxygen-treated polyethylene, wherein said contacting occurs in said melt-conveying zone.

2. The process of claim 1, wherein said gas mixture comprises a lower limit of one of 0.5%, or 0.75%, or 1.0%, or 1.5%, or 2.0%, or 2.5%, or 2.75%, or 3.0% by volume oxygen and/or an upper limit of one of 7.9%, or 7.5%, or 7.0%, or 6.5%, or 6.0, or 5.0, or 5.5%, or 5.0%, or 4.75%, or 4.5%, or 4.0% by volume oxygen.

3. The process of claims 1 or 2 wherein said mixer/extruder further comprises a feed zone and/or a melting zone.

4. The process of claim 3 wherein said gas mixture is introduced to said melt-conveying zone in one of a single port, a counter flow or a co-flow with said substantially melted polyethylene.

5. The process of claim 4 wherein said polyethylene comprises ethylene and one or more of propylene; 3-methyl-1-butene; 3,3-dimethyl-1-butene; 1-pentene; 1-pentene with one or more methyl, ethyl or propyl substituents; 1-hexene; 1-hexene with one or more methyl, ethyl or propyl substituents; 1-heptene; 1-heptene with one or more methyl, ethyl or propyl substituents; 1-octene; 1-octene with one or more methyl, ethyl or propyl substituents; 1-nonene; 1-nonene with one or more methyl, ethyl or propyl substituents; ethyl, methyl or dimethyl-substituted 1-decene; 1-dodecene; or styrene.

6. The process of claim 5 wherein said polyethylene has an elasticity G′/G″ of at least 10, or 20, or 30, or 40, or 50% greater than a comparable polyethylene mixed/extruded under similar conditions, in the substantial absence of oxygen.

7. The process of claim 6 wherein said polyethylene has a density in the range of from 0.900 g/cm³-0.970 g/cm³.

8. The process of claim 6 wherein said polyethylene has a density in the range of from 0.912 g/cm³-0.930 g/cm³.

9. The process of claim 6 wherein said polyethylene has a density in the range of from 0.930 g/cm³-0.970 g/cm³.

10. The process of claim 6 wherein said polyethylene has a density in the range of from 0.945 g/cm³-0.970 g/cm³.

11. The process of claim 7 wherein said polyethylene has a multimodal molecular weight distribution or a multimodal composition distribution or both.

12. The process of claim 11, wherein said polyethylene is a physical blend, or made with two or more catalysts in a single or multiple reactors.

13. The process of claim 1, wherein said polyethylene is unimodal.

14. The process of claim 3, wherein said substantially melted polyethylene is contacted with said gas mixture in a portion of said mixer/extruder consisting essentially of said melt-conveying zone.

15. The process of claim 1 further comprises pelletizing said oxygen treated polyethylene.

16. The process of claims 1 or 15, further comprising forming said pelletized oxygen-treated polyethylene or said oxygen treated polyethylene into a film.

17. The process of claims 1 or 15, further comprising forming said pelletized oxygen-treated polyethylene or said oxygen treated polyethylene into a blow molded article.

18. The process of claims 1 or 15, further comprising forming said pelletized oxygen-treated polyethylene or said oxygen treated polyethylene into an injected molded article.

19. The process of claims 1 or 15, further comprising forming said pelletized oxygen-treated polyethylene or said oxygen treated polyethylene into an extruded article.

20. A process for producing a polyethylene resin useful in blown film, said resin having improved bubble stability during blown film extrusion, comprising:
a) introducing a granular polyethylene homopolymer or copolymer into a mixer/extruder;
b) conveying said granular polyethylene through a feed zone, and/or a melting zone and a melt-conveying zone of said mixer/extruder;
c) introducing a gas mixture to said melt-conveying zone, said melt-conveying zone comprising said gas mixture said polyethylene homopolymer or copolymer substantially melted, said gas mixture comprising in the range of 2.5% to 4.5% by volume oxygen, the remainder of said gas mixture comprising a non-reactive gas or a mixture of non-reactive gases, said gas mixture flowing in one of, the same direction or opposite direction of said substantially melted polyethylene homopolymer or copolymer in said melt-conveying zone, to form an oxygen treated polyethylene homopolymer or copolymer;
d) processing said oxygen-treated polyethylene homopolymer or copolymer further by:
i) pelletizing; or
ii) forming into a film; or
iii) pelletizing and forming into a film;
wherein said polyethylene homopolymer or copolymer comprises a density of 0.930 g/cm³-0.970 g/cm³, and an elasticity (G′/G″) at least 30% higher than a comparable polyethylene homopolymer or copolymer mixed/extruded in the substantial absence of oxygen.

21. A process for producing a polyethylene having improved bubble stability and improved gauge uniformity during blown film production, comprising:
a) introducing a granular polyethylene homopolymer or copolymer into a mixer/extruder;
b) conveying said granular polyethylene through a feed zone, and/or a melting zone and a melt-conveying zone of said mixer/extruder;
c) introducing a gas mixture to said melt-conveying zone, said melt-conveying zone consisting essentially of an extruder screw element and barrel, said gas mixture and said polyethylene homopolymer or copolymer, substantially melted; said gas mixture comprising in the range of 3% to 4% by volume oxygen, the remainder of said gas mixture comprising a non-reactive gas or a mixture of non-reactive gases, said gas mixture flowing in one of, the same direction or opposite direction of said substantially melted polyethylene homopolymer or copolymer in said melt-conveying zone, to form an oxygen treated polyethylene homopolymer or copolymer;
d) processing said oxygen-treated polyethylene homopolymer or copolymer further by:
i) pelletizing; or
ii) forming into a film; or
iii) pelletizing and forming into a film;
wherein said polyethylene homopolymer or copolymer comprises a density of 0.930 g/cm³-0.970 g/cm³, and an elasticity (G′/G″) at least 40% higher than a comparable polyethylene homopolymer or copolymer mixed/extruded in the substantial absence of oxygen.

22. A process of tailoring a polyethylene, comprising:
a) introducing a granular polyethylene into a mixer/extruder;
b) conveying said granular polyethylene through a feed zone, and/or a melting zone and a melt-conveying zone of said mixer/extruder, wherein said feed zone and said melting zone are substantially free of oxygen;
c) introducing a gas mixture to said melt-conveying zone, said melt-conveying zone comprising said gas mixture and said polyethylene, substantially melted; said gas mixture comprising in the range of 3% to 4% by volume oxygen, the remainder of said gas mixture comprising a non-reactive gas or a mixture of non-reactive gases, said gas mixture flowing in one of, the same direction or opposite direction of said substantially melted polyethylene homopolymer or copolymer in said melt-conveying zone, to form an oxygen treated polyethylene homopolymer or copolymer;
d) processing said oxygen-treated polyethylene further by:
i) pelletizing; or
ii) forming into a film; or
iii) pelletizing and forming into a film;
wherein said polyethylene homopolymer or copolymer comprises a density of 0.930 g/cm³-0.970 g/cm³, and an elasticity (G′/G″) at least 40% higher than a comparable polyethylene mixed/extruded in the substantial absence of oxygen.
